(19) United States
(12) Patent Application Publication
(10) Pub. No.: US 2005/0208990 A1
(43) Pub. Date: Sep. 22, 2005

(54) Number by number lotto game and method

(76) Inventor: Frank D. Moore, Cooper, TX (US)

Correspondence Address: Derek R. Van Gilder, 916 Main Street, Bastrop, TX, 78602, US

(21) Appl. No.: 10/803,830

(22) Filed: Mar. 18, 2004

(51) Int. Cl. A63F 13/00

(52) U.S. Cl. 463/17

(57) ABSTRACT

A number-by-number lotto game and method having one ultimate top jackpot (1) and one or more secondary base jackpots (2). A predeterminedly large portion of lottery net intake (3) is put into the top jackpot. Remainder lottery money intake, exclusive of lotto costs (29) and planned revenue (28), is put into a payout amount (30) for the top jackpot and the one or more base jackpots. Gaming methods (5) for determining payout proportions are determined and adjusted for maximizing lotto revenue by achieving most favorable motivation for lotto gambling. An advertising program (21) is employed for identifying a selected number plurality for an embodiment of the number-by-number lotto game with a popular item. A preferred embodiment is a four-by-four lotto game (25) having one top jackpot and four base jackpots that is advertised by identification with a 4 by 4 pickup (27) in a state like Texas where 4 by 4 pickups are popular.

### BACKGROUND OF THE INVENTION

1. Field of the Invention

This invention relates to a lotto game having one prime jackpot with high payout resulting from adjustably high loss odds and one or more base jackpots with proportionately lower payout resulting from adjustable lower loss odds.

2. Relation to Prior Art

Lottery participation has declined with proportionate decrease in its returns for host-government revenue. The reason is based on a complexity of gambling motivation that many present governments now support for revenue purposes.

Nearly all lottery gamblers have an ultimate gambling goal of becoming a multimillionaire, but would be much more likely to gamble on becoming a multimillionaire if gambling on becoming a multimillionaire also gave them a slightly better gambling chance of becoming only a millionaire.

This is because lottery-gambling has evolved a present gambling culture of gambling for the purpose of making enough money to improve life style to an image level of either a multimillionaire or, if not, then making only enough for a millionaire life style with slightly better odds.

Volume of lottery gambling increases greatly with increase in jackpot size. This tends to establish a gambling-public preference for odds against winning to be sufficiently high to maximize payout to an ultimate winner.

The decline in lotto-gambling is mostly because a growing lotto-player desire for better odds for winning a secondary millionaire jackpot if a primary multimillionaire jackpot with worse odds is not won. A lotto-gambling motivation for winning the primary multimillionaire jackpot would be much more appealing if a lotto gamble included at least one better-odds chance of winning the secondary millionaire jackpot.

The proportion of lotto-gambling public who have a secondary millionaire motivation by playing for a primary motivation to win the ultimate multimillionaire jackpot is well over one-half of the lotto-gamblng public.

Lotto players who gamble only for the ultimate multimillionaire jackpot would not be dissuaded significantly from playing if size of the primary multimillionaire jackpot were decreased sufficiently for providing payout amounts for one or more secondary millionaire base jackpots.

Small wins for picking portions of winning numbers do not satisfy the lottery-gambling motivation to win a better life style. They are a comparatively insulting indignity that is counterproductive to lottery volume.

This invention is to fill an economic demand for a gambling chance to become either a multimillionaire or a millionaire and for generating government revenue.

Listed below for consideration is known related prior art:

| Number | Date | Inventor | U.S. Class |
|---|---|---|---|
| U.S. Pat. No. 5,979,894 | November 1999 | Alexoff | 273/139 |
| U.S. Pat. No. 5,772,511 | June 1998 | Smeltzer | 463/17 |
| U.S. Pat. No. 5,232,221 | August 1993 | Sludikoff, et al. | 273/139 |
| U.S. Pat. No. 5,186,463 | February 1993 | Marin, et al. | 273/138R |
| U.S. Pat. No. 5,158,293 | October 1992 | Mullins | 273/139 |
| U.S. Pat. No. 5,116,049 | May 1992 | Sludikoff, et al. | 273/139 |

### SUMMARY OF THE INVENTION

Objects of patentable novelty and utility taught by this invention are to provide a number-by-number lotto game and method which:
induces more lotto participation by appealing to both a multimillionaire objective and to a millionaire objective of gambling in a single lotto game with adjusted odds for winning each;
increases revenue returns to government by increasing gambling volume without increase in payout costs; and
provides lotto advertising which relates lotto to other things that people like, starting with a 4×4 pickup in parts of the U.S. where they are popular.

This invention accomplishes these and other objectives with a number-by-number lotto game and method having one ultimate top jackpot and one or more secondary base jackpots. A predeterminedly large portion of lottery money intake is put into the top jackpot. Remainder lottery money intake is put into the one or more base jackpots. Gambling methods and payout proportions are determined and adjusted for maximizing lotto revenue by achieving most favorable motivation for lotto gambling. An advertising method is based on identifying a selected number plurality for an embodiment of the number-by-number lotto game with a popular item. A preferred embodiment is a four-by-four lotto game having one top jackpot and four base jackpots that is advertised by identification with a 4 by 4 pickup in a state like Texas where 4 by 4 pickups are popular.

### BRIEF DESCRIPTION OF DRAWINGS

This invention is described by appended claims in relation to description of a preferred embodiment with reference to the following drawings which are explained briefly as follows:

FIG. 1 is a block diagram of the basic number-by-number lotto game with arrows indicating primarily flow of lottery money;

FIG. 2 is a block diagram of the number-by-number lotto game having top-jackpot steps separately from base-jackpot steps for determining top-jackpot winners and base-jackpot winners;

FIG. 3 is a block diagram of the number-by-number lotto game having a single random selection of winning balls for determining both top winners and base winners;

FIG. 4 is a block diagram of the number-by-number lotto game having separate random selection of winning balls for determining both top winners and base winners;

FIG. 5 is a block diagram of the number-by-number lotto game having separate random selection of winning numbered objects with optional hand selection blindly and machine selection for determining both top winners and base winners;

FIG. 6 is a block diagram of a one-by-one embodiment of the number-by-number lotto game having an advertisement program for identification of the lotto game with a popular item that can include a 4×4 pickup truck and having a gaming method with top-jackpot steps separate from base-jackpot steps;

FIG. 7 is a block diagram of a two-by-two embodiment of the number-by-number lotto game having the advertisement program for identification of the lotto game with a popular item that can include any appropriately popular item and having a gaming method with top-jackpot steps separate from base-jackpot steps;

FIG. 8 is a block diagram of a four-by-four embodiment of the number-by-number lotto game having an advertisement program for identification of the lotto game with a popular item that can include a 4×4 pickup truck and having a gaming method with the top-jackpot steps separate from the base-jackpot steps;

FIG. 9 is a block diagram of the one-by-one embodiment of the number-by-number lotto game having an advertisement program for identification of the lotto game with a popular item that can include the 4×4 pickup truck and having a gaming method with a select-all jackpots step for determining the top winner and base winners;

FIG. 10 is a block diagram of the two-by-two embodiment of the number-by-number lotto game having an advertisement program for identification of the lotto game with a popular item and having a gaming method with the select-all jackpot steps for determining the top winner and base winners; and

FIG. 11 is a block diagram of the four-by-four embodiment of the number-by-number lotto game having an advertisement program for identification of the lotto game with a popular item that can include the 4×4 pickup truck and having a gaming method with the select-all jackpots step for determining the top winner and base winners.

### DESCRIPTION OF PREFERRED EMBODIMENT

Listed numerically below with reference to the drawings are terms used to describe features of this invention. These terms and numbers assigned to them designate the same features throughout this description.

```
  1. Top jackpot
  2. Base jackpot
  3. Net intake
  4. Lotto tickets
  5. Gaming method
  6. Top winner
  7. Base winners
  8. Winning numbered balls
  9. Lot of numbered balls
10. Top-jackpot lot
11. Top-jackpot step
12. Base-jackpot steps
13. Top numbered balls
14. Base-jackpot lots
15. Base numbered balls
16. Winning numbered objects
17. Top-jackpot lot of numbered objects
18. Base-jackpot lot of numbered objects
19. Hand selections
20. Machine selections
21. Advertisement program
22. Popular item
23. One-by-one lotto game
24. Two-by-two lotto game
25. Four-by-four lotto game
26. Select-all-jackpots step
27. 4 × 4 pickup truck
28. Planned revenue
29. Lotto costs
30. Payout amount
31. First television ad
32. Second television ad
33. Third television ad
34. Fourth television ad
```

There are a wide variety of number-relatable objects that have popular appeal. Most popular are one-by-one, two-by-two and four-by-four. One-by-one can be a person and a waterfall, a flower, a vehicle or other object. Two-by-two can be pairs or couples of people, birds and other objects. Four-by-four can include the popular 4×4 pickup and sport utility vehicle (SUV).

This invention structures a lotto payout amount into parts with a high multimillionaire portion and one or more secondary or base millionaire portions which can be identifiable with popular number-related objects for effective advertising. A 4×4 pickup is used as an example of a popular number-related item.

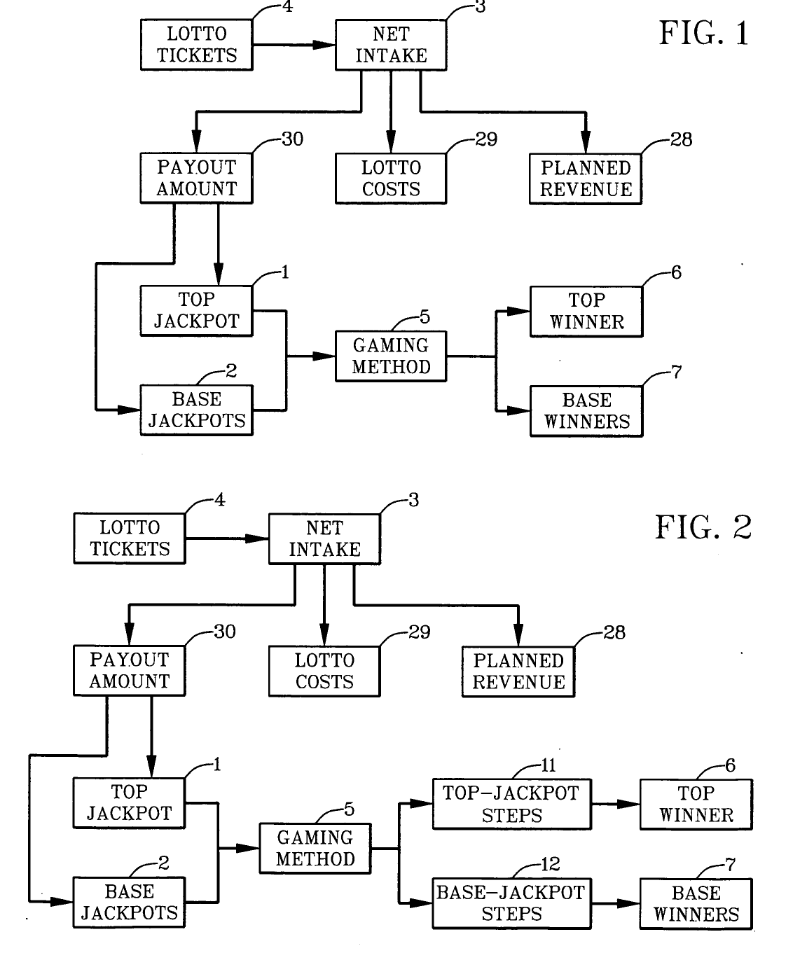

Referring to FIGS. 1-5, the number-by-number lotto game has one top jackpot 1 and one or more base jackpots 2. The top jackpot 1 is structured for receiving a predetermined large portion of net intake 3 from a sale of lotto tickets 4 and the one or more base jackpots 2 are structured for receiving a predetermined small portion of the net intake 3. A gaming method 5 is employed for determining a top winner 6 of the top jackpot 1 and for determining one or more base winners 7 for winning the one or more base jackpots 2 respectively. Organization of the gaming method 5 for determining the top winner 6 of the top jackpot 1 and the base winners 7 is structured for advertising identification with at least one popular item.

The large portion of the net intake 3 from the sale of the lotto tickets 4 and the small portion of the net intake 3 from the sale of the lotto tickets 4 are adjustable by applicable lotto-host authority for achieving a planned revenue 28 after accounting for all lotto costs 29 and a payout amount 30 for the top jackpot 1 and the base jackpots 2.

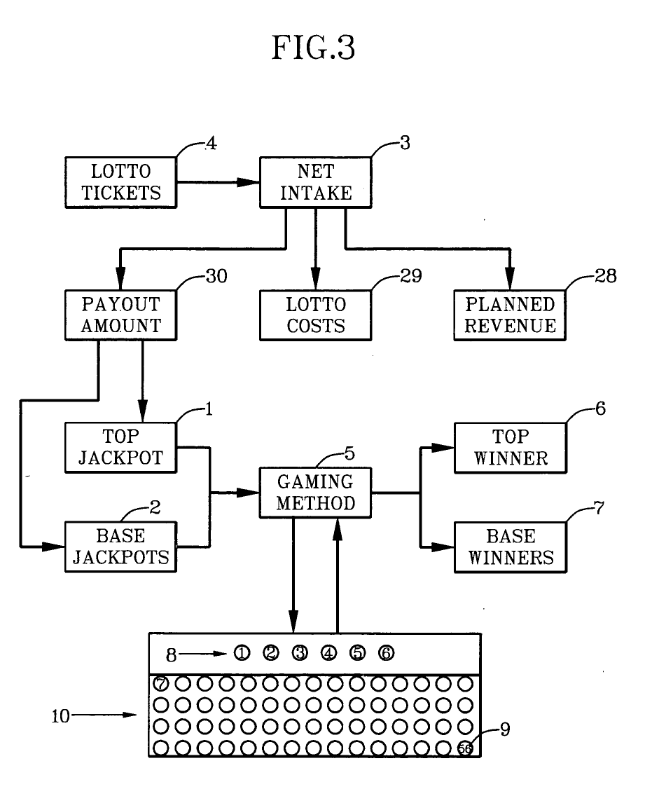

The gaming method 5 can include a random selection of a predetermined plurality of winning numbered balls 8 from a predetermined plurality of a top-jackpot lot 10 of numbered balls 9 as depicted in FIG. 3.

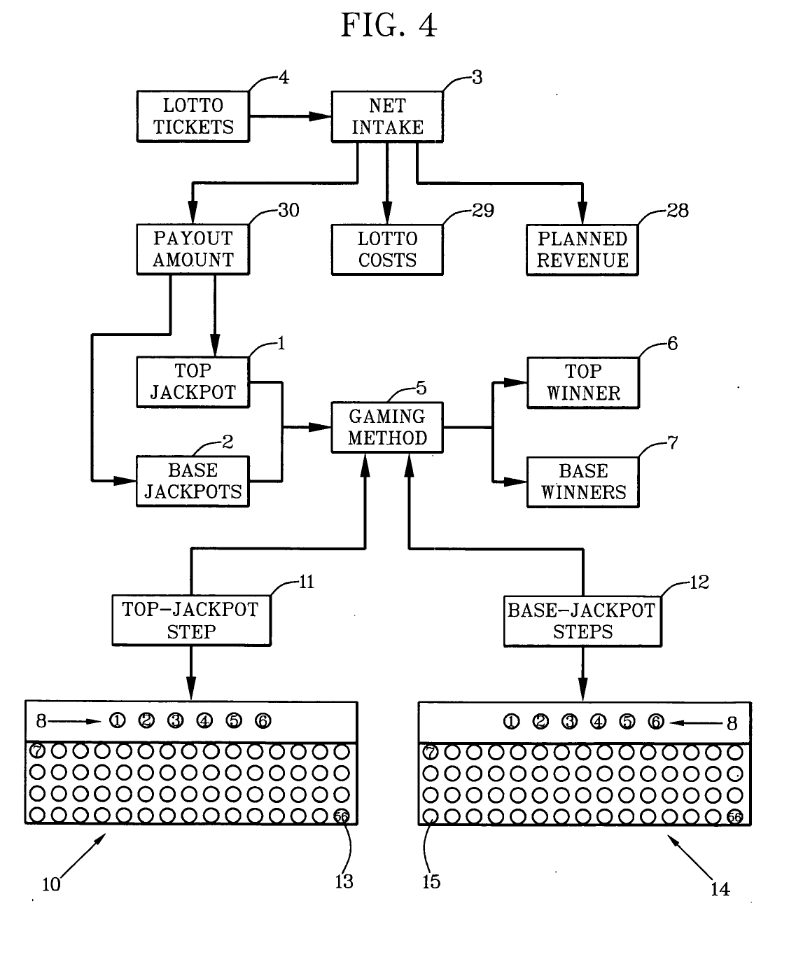

Optionally, the gaming method 5 can includes a top-jackpot step 11 for determining the top winner 6 of the top jackpot 1 and one or more base-jackpot steps 12 for determining the one or more base winners 7 of the base-jackpots 2 respectively. The top-jackpot step 11 can include a first random selection of a predetermined plurality of winning numbered balls 8 from a predetermined plurality of a top-jackpot lot 10 of top numbered balls 13. Also, the one or more base-jackpot steps 12 for determining the one or more base winners 7 of the base jackpots 2 respectively can include one or more second selections of one or more predetermined pluralities of the winning numbered balls 8 from one or more predetermined pluralities of base-jackpot lots 14 of base numbered balls 15 as depicted in FIG. 4.

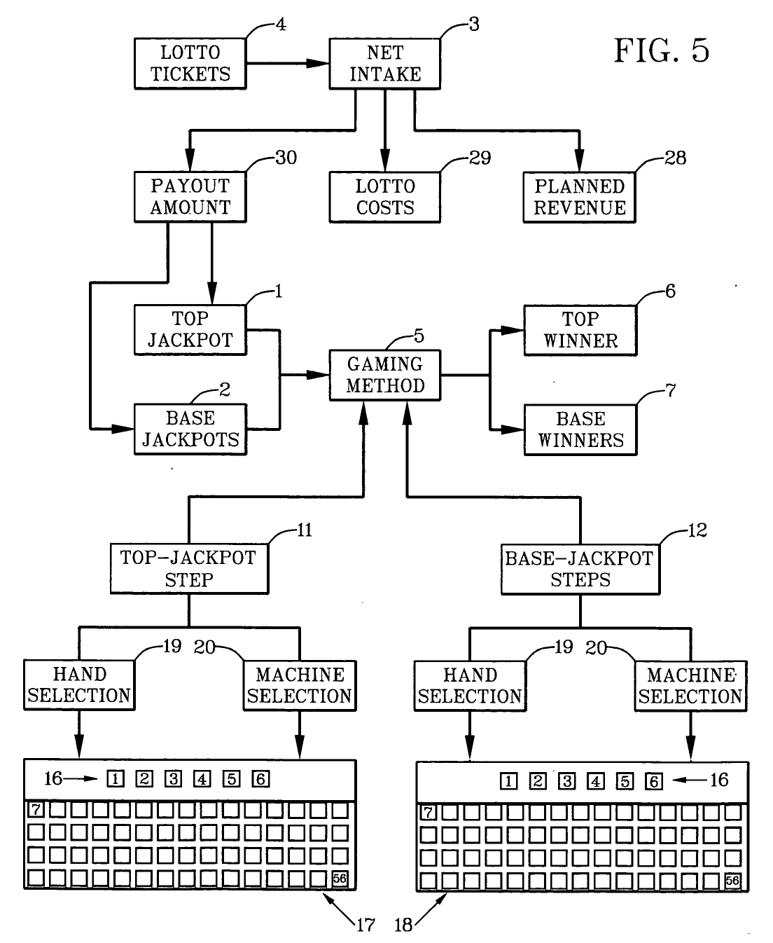

Optionally to using balls, as shown in FIG. 5, the top-jackpot step 11 can include a first random selection of a predetermined plurality of winning numbered objects 16 from a predetermined plurality of a top-jackpot lot of numbered objects 17. The one or more base-jackpot steps 12 for determining the one or more base winners 7 of the base jackpots 2 respectively can include one or more second selections of one or more predetermined pluralities of the winning numbered objects 16 from one or more predetermined pluralities of base-jackpot lots of numbered objects 18.

The first random selection and the second random selection can include hand selections 19 that are made blindly. Optionally, the first random selection and the second random selection include machine selections 20 that are made randomly.

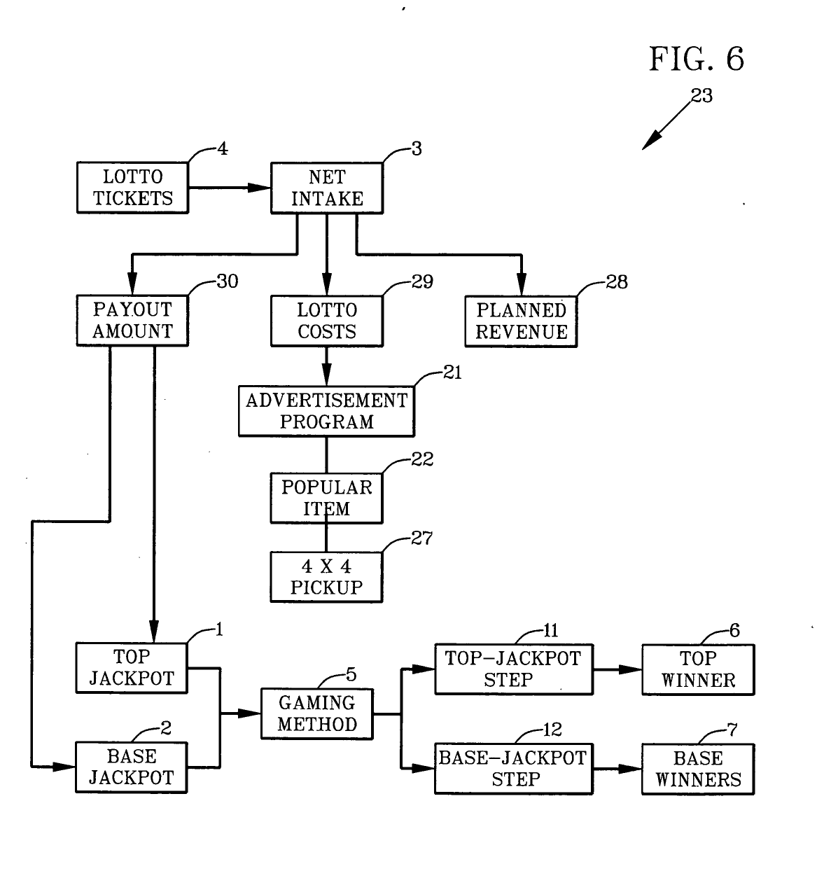

Referring to FIGS. 6-8, included preferably is an advertisement program 21 having an advertisement method for identifying the number-by-number lotto game with an appropriately popular item 22.

As depicted in FIG. 6, the number-by-number lotto game can include a one-by-one lotto game 23 having the top jackpot 1 and one base jackpot 2 while the gaming method 5 can include the top-jackpot step 11 for determining the top winner 6 of the top jackpot 1 and one base-jackpot step 12 for determining the base winners 7 of the base jackpot 2 respectively.

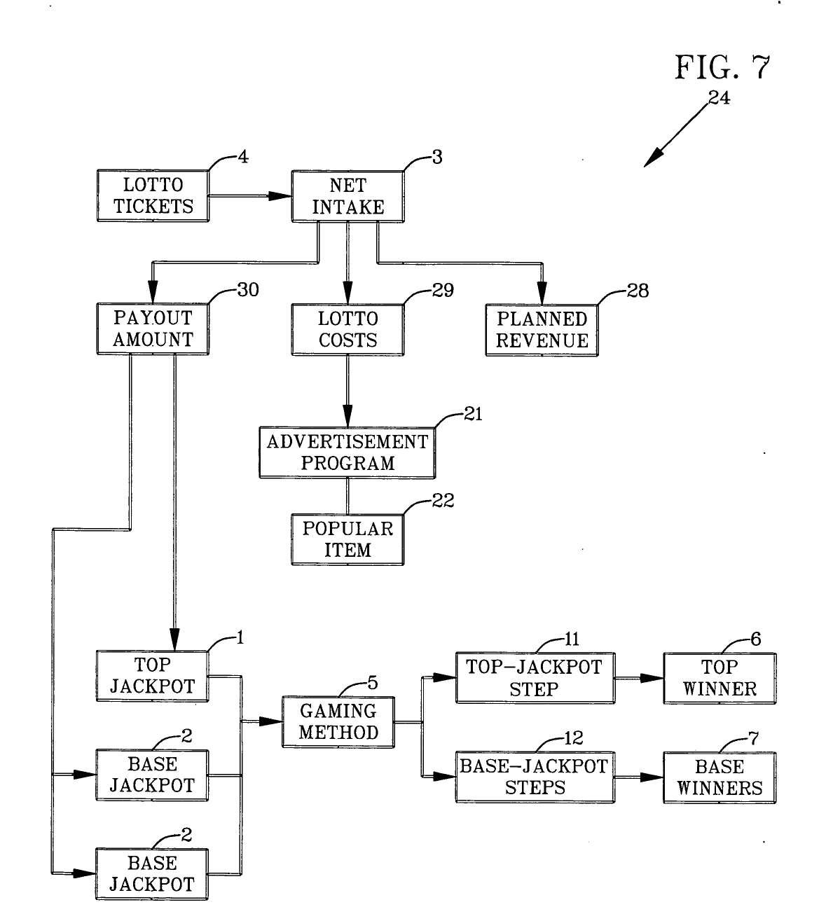

As depicted in FIG. 7, the number-by-number lotto game can include a two-by-two lotto game 24 having the top jackpot 1 and two base jackpots 2 while the gaming method 5 can include the top-jackpot step 11 for determining the top winner 6 of the top jackpot 1 and two base-jackpot steps 12 for determining the base winners 7 of the base jackpots 2 respectively.

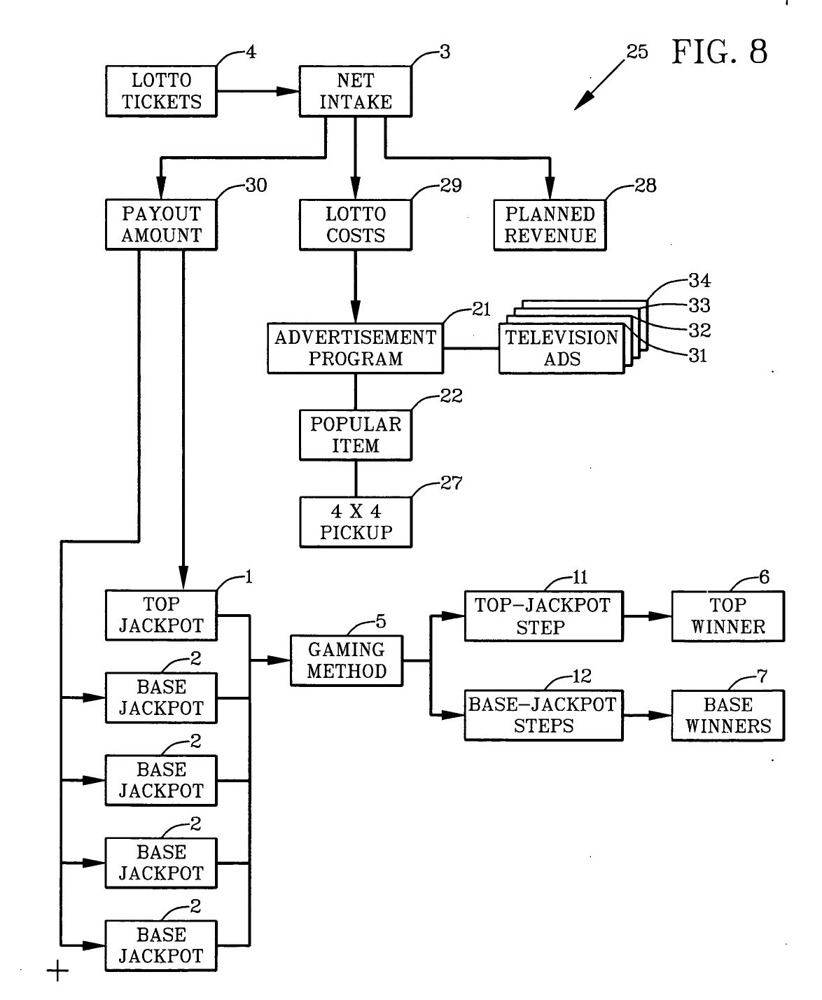

As depicted in FIG. 8, for states where 4×4 pickup trucks are popular, the number-by-number lotto game can include a four-by-four lotto game 25 having the top jackpot 1 and four base jackpots 2 while the gaming method 5 can include the top-jackpot step 11 for determining the top winner 6 of the top jackpot 1 and four base-jackpot steps 12 for determining base winners 7 of the four base jackpots 2 respectively.

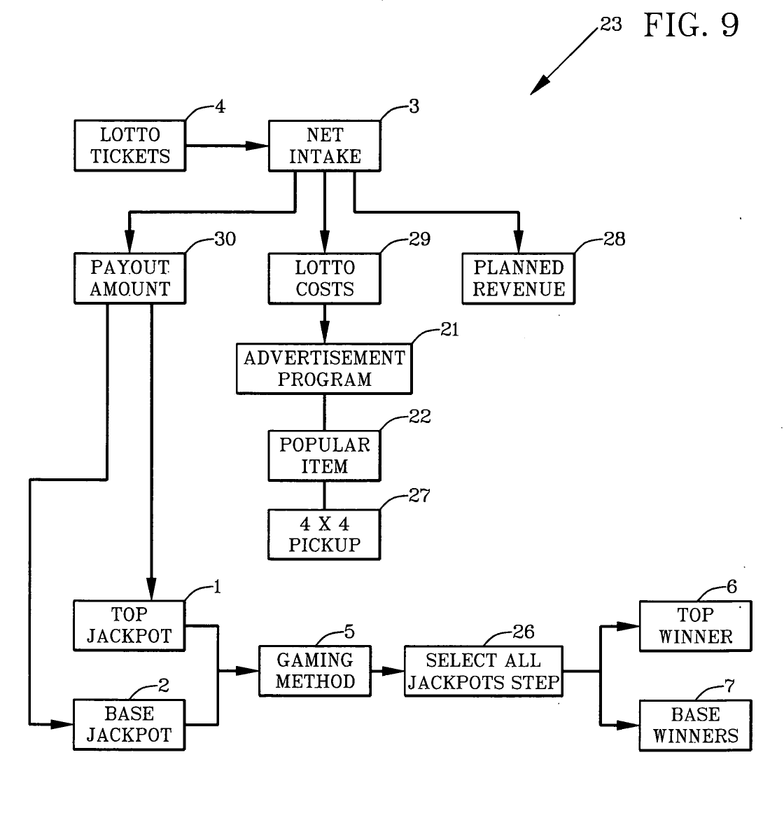

Referring to FIGS. 9-11, the number-by-number lotto game can includes the one-by-one lotto game 23 having the top jackpot 1 and one base jackpot 2 while the gaming method 5 can includes a select-all-jackpots step 26 for determining the top winner 6 of the top jackpot 1 the base winner 7 of the one base jackpot 2 as depicted in FIG. 9.

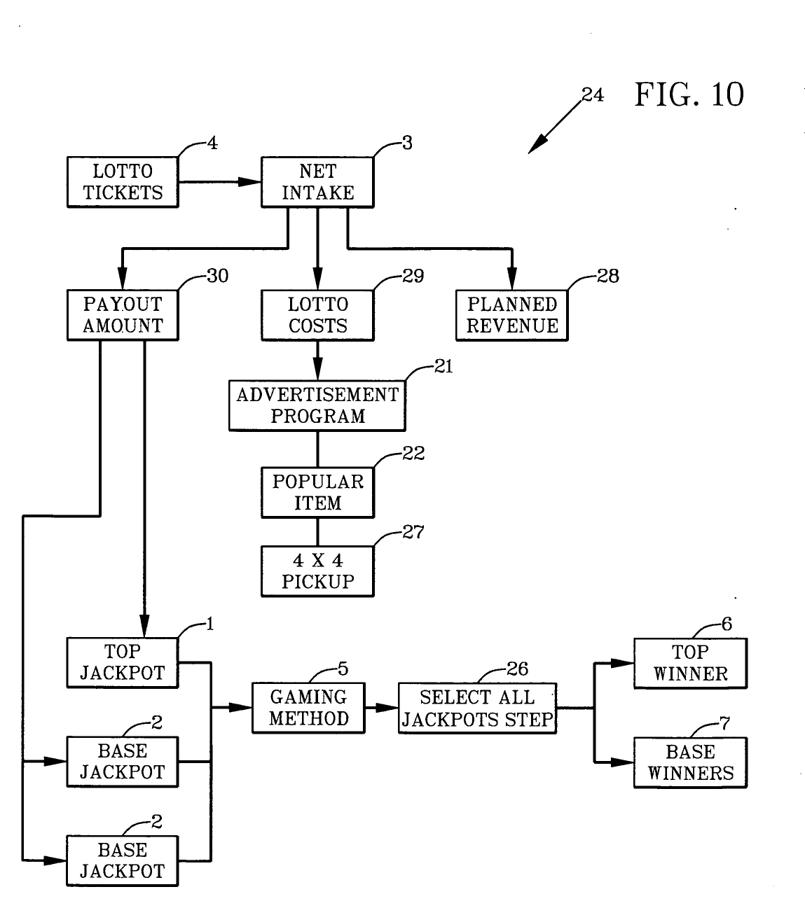

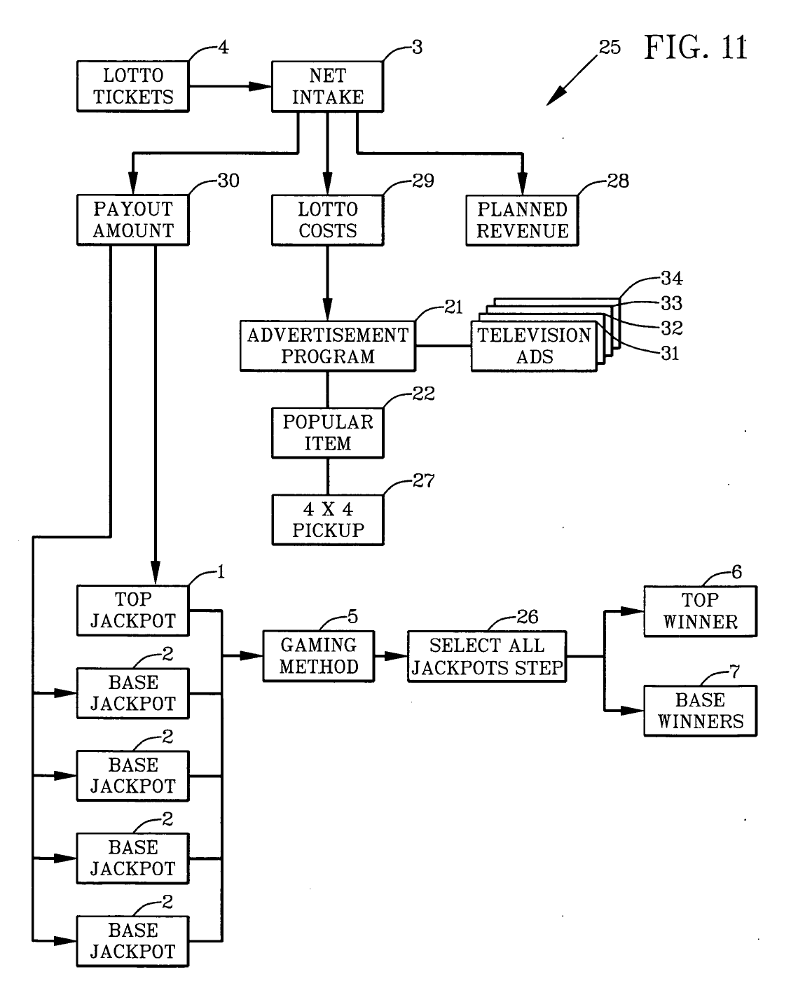

The number-by-number lotto game can include the two-by-two lotto game 24 having the top jackpot 1 and two base jackpots 2 while the gaming method 5 can include the select-all-jackpots step 26 for determining the top winner 6 of the top jackpot 1 and the base winners 7 of the two base-jackpots 2 as depicted in FIG. 10.

The number-by-number lotto game can include the four-by-four lotto game 25 having the top jackpot 1 and the four base jackpots 2 for which the gaming method 5 can include the select-all-jackpots step 26 for determining the top winner 6 of the top jackpot 1 and for determining the base winners 7 of the four base-jackpots 2 as depicted in FIG. 11.

A method can comprise the following steps for advertising the four-by-four lotto game of claim 16:
preparing a first television ad 31 showing a working cowboy pulling up to a country store in an old 4×4 pickup truck which has hay and a diesel tank in the back;
the ad showing the cowboy getting out of the 4×4 pickup, going into the country store and saying to the store clerk, “Give me ten dollars of those 4 by 4 lottery tickets;”
the ad showing the cowboy getting the tickets, walking out the door, looking towards a television camera and saying, “I drive a 4×4 and I play 4 by 4 lotto and they're both great;” and
running the first television ad 31 repeatedly at selected times over a selected period of time.

The method can further comprise:
preparing a second television ad 32 showing the cowboy in the country store with his 4×4 pickup outside;
the ad then showing a bright new red 4×4 pickup driving up to the country store;
the ad then showing a very pretty girl dressed in Western clothes getting out of the new red 4×4 pickup, walking up to the clerk and saying in a very soft voice, “Could I please have ten of those 4 by 4 lotto tickets;”
the ad then showing the pretty girl getting the tickets, starting out the door, turning towards the cowboy who is standing nearby and who has been watching her all of the time, and saying, “I also drive a 4×4 and play the 4 by 4 lotto and you are right, they are both great;”
the ad then showing the pretty girl driving off in her red 4×4 pickup; and
running the second television ad 32 repeatedly at selected times over a selected period of time.

The method can further comprise:
preparing a third television ad 33 showing an eighteen-wheeler truck driving up to the country store;
the ad showing a driver of the eighteen-wheeler truck going inside of the country store and saying to the clerk, “I want eighteen chances for the 4 by 4 lotto, pickup drivers are not the only ones who play the 4 by 4 lotto;” and
running the third television ad 33 repeatedly at selected times over a selected period of time.

The method can further comprise:
preparing a fourth television ad 34 showing a 4×4 pickup parked outside of a store;
the ad showing a person, male or female, walking out of the store and seeing the 4×4 pickup, says, “Oops, I forgot my lottery ticket;”
the ad then showing the person turning around to go back into the store; and
running the fourth television ad 34 repeatedly at selected times over a selected period of time.

A new and useful number-by-number lotto game and method having been described, all such foreseeable modifications, adaptations, substitutions of equivalents, mathematical possibilities of combinations of parts, pluralities of parts, applications and forms thereof as described by the following claims and not precluded by prior art are included in this invention.

1. A number-by-number lotto game comprising:
one top jackpot and one or more base jackpots;
the top jackpot being structured for receiving a predetermined large portion of net intake from a sale of lotto tickets;
the one or more base jackpots being structured for receiving a predetermined small portion of the net intake from the sale of the lotto tickets in proportion to the large portion of the net intake from the sale of the lotto tickets which the top jackpot is structured to receive predeterminedly;
a gaming method for determining a top winner of the top jackpot and for determining one or more base winners for winning the one or more base jackpots respectively; and
organizational structure of the jackpots and gaming methods employed is structured for advertising identification with at least one popular item.

2. The number-by-number lotto game of claim 1 wherein:
the large portion of the net intake from the sale of the lotto tickets for which the top jackpot is structured to receive and the small portion of the net intake from the sale of the lotto tickets for which the one or more base jackpots are structured to receive are adjustable by applicable lotto-host authority for achieving a planned revenue after accounting for all lotto costs and a payout amount for the top jackpot and the base jackpots.

3. The number-by-number lotto game of claim 1 wherein:
the gaming method includes a random selection of a predetermined plurality of winning numbered balls from a predetermined plurality of a top-jackpot lot of numbered balls.

4. The number-by-number lotto game of claim 1 wherein:
the gaming method includes a top-jackpot step for determining the top winner of the top jackpot and one or more base-jackpot steps for determining the one or more base winners of the base jackpots respectively.

5. The number-by-number lotto game of claim 4 wherein:
the top-jackpot step includes a first random selection of a predetermined plurality of winning numbered balls from a predetermined plurality of a top-jackpot lot of top numbered balls; and
the one or more base-jackpot steps for determining the one or more base winners of the base jackpots respectively includes one or more second selections of one or more predetermined pluralities of the winning numbered balls from one or more predetermined pluralities of base-jackpot lots of base numbered balls.

6. The number-by-number lotto game of claim 4 wherein:
the top-jackpot step includes a first random selection of a predetermined plurality of winning numbered objects from a predetermined plurality of a top-jackpot lot of numbered objects; and
the one or more base-jackpot steps for determining the one or more base winners of the base jackpots respectively include one or more second selections of one or more predetermined pluralities of the winning numbered objects from one or more predetermined pluralities of base-jackpot lots of numbered objects.

7. The number-by-number lotto game of claim 6 wherein:
the first random selection and the second random selection include hand selections that are made blindly.

8. The number-by-number lotto game of claim 6 wherein:
the first random selection and the second random selection include machine selections that are made randomly.

9. The number-by-number lotto game of claim 1 and further comprising:
an advertisement program having an advertisement method for identifying the number-by-number lotto game with a predeterminedly popular item.

10. The number-by-number lotto game of claim 1 wherein:
the number-by-number lotto game includes a one-by-one lotto game having the top jackpot and one base jackpot; and
the gaming method includes the top-jackpot step for determining the top winner of the top jackpot and one base-jackpot step for determining the base winner of the base jackpot respectively.

11. The number-by-number lotto game of claim 1 wherein:
the number-by-number lotto game includes a two-by-two lotto game having the top jackpot and two base jackpots; and
the gaming method includes the top-jackpot step for determining the top winner of the top jackpot and two base-jackpot steps for determining the base winners of the base jackpots respectively.

12. The number-by-number lotto game of claim 1 wherein:
the number-by-number lotto game includes a four-by-four lotto game having the top jackpot and four base jackpots; and
the gaming method includes the top-jackpot step for determining the top winner of the top jackpot and four base-jackpot steps for determining base winners of the base jackpots respectively.

13. The number-by-number lotto game of claim 1 wherein:
the number-by-number lotto game includes the one-by-one lotto game having the top jackpot and one base jackpot; and
the gaming method includes a select-all-jackpots step for determining the top winner of the top jackpot and the one base jackpot.

14. The number-by-number lotto game of claim 1 wherein:
the number-by-number lotto game includes the two-by-two lotto game having the top jackpot and two base jackpots; and
the gaming method includes the select-all-jackpots step for determining the top winner of the top jackpot and the two base-jackpots.

15. The number-by-number lotto game of claim 1 wherein:
the number-by-number lotto game includes the four-by-four lotto game having the top jackpot and four base jackpots; and
the gaming method includes the select-all-jackpots step for determining the top winner of the top jackpot and the four base-jackpots.

16. A four-by-four lotto game comprising:
one top jackpot and four base jackpots;
the top jackpot being structured for receiving a predetermined large portion of net intake from a sale of lotto tickets;
the four base jackpots being structured for receiving a predetermined small portion of the net intake from the sale of the lotto tickets in proportion to the large portion of the net intake from the sale of the lotto tickets which the top jackpot is structured to receive predeterminedly;
a gaming method for determining a top winner of the top jackpot and for determining four base winners for winning the four base jackpots respectively;
the large portion of the net intake from the sale of the lotto tickets for which the top jackpot is structured to receive and the small portion of the net intake from the sale of the lotto tickets for which the four base jackpots are structured to receive are adjustable by applicable lotto-host authority for achieving a desired public opinion of the number-by-number lotto game; and
an advertisement method for identifying the four-by-four lotto game with an appropriately popular item that includes a 4×4 pickup.

17. A method comprising the following steps for advertising the four-by-four lotto game of claim 16;
preparing a first television ad showing a working cowboy pulling up to a country store in an old 4×4 pickup which has hay and a diesel tank in the back;
the ad showing the cowboy getting out of the pickup, going into the country store and saying to the store clerk, “Give me ten dollars of those 4 by 4 lottery tickets;”
the ad showing the cowboy getting the tickets, walking out the door, looking towards a television camera and saying, “I drive a 4×4 and I play 4 by 4 lotto and they're both great;” and
running the first television ad repeatedly at selected times over a selected period of time.

18. The method of claim 17 and further comprising:
preparing a second television ad showing the cowboy in the country store with his 4×4 pickup outside;
the ad showing a bright new red 4×4 pickup driving up to the country store;
the ad showing a very pretty girl dressed in Western clothes getting out of the new red 4×4 pickup, walking up to the clerk and saying in a very soft voice, “Could I please have ten of those 4 by 4 lotto tickets;”
the ad showing the pretty girl getting the tickets, starting out the door, turning towards the cowboy who is standing nearby and who has been watching her all of the time, and saying, “I also drive a 4×4 and play the 4 by 4 lotto and you are right, they are both great;
the ad showing the pretty girl driving off in her red 4×4 pickup; and
running the second television ad repeatedly at selected times over a selected period of time.

19. The method of claim 18 and further comprising:
preparing a third television ad showing an eighteen-wheeler truck driving up to the country store;
the ad showing a driver of the eighteen-wheeler truck going inside of the country store and saying to the clerk, “I want eighteen chances for the 4 by 4 lotto, pickup drivers are not the only ones who play the 4 by 4 lotto;” and
running the third television ad repeatedly at selected times over a selected period of time.

20. The method of claim 18 and further comprising:
preparing a fourth television ad showing a 4×4 pickup parked outside of a store;
the ad showing a person, male or female, walking out of the store and seeing the 4×4 pickup, says, “Oops, I forgot my lottery ticket;”
the ad showing the person tuning around to go back into the store; and
running the fourth television ad repeatedly at selected times over a selected period of time.
